(19) United States
(12) Patent Application Publication
(10) Pub. No.: US 2022/0358835 A1
(43) Pub. Date: Nov. 10, 2022

(54) METHODS AND SYSTEMS FOR AUTOMATICALLY DETECTING VIOLATION OF A DRIVING-RELATED LAW

(71) Applicant: Joshua Grady Graver, Boston, MA (US)

(72) Inventor: Joshua Grady Graver, Boston, MA (US)

(21) Appl. No.: 17/642,900

(22) PCT Filed: Sep. 15, 2020
(86) PCT No.: PCT/US2020/050832

§ 371 Date: Mar. 14, 2022

Related U.S. Application Data
(60) Provisional application No. 62/900,717, filed on Sep. 16, 2019.

(51) Int. Cl. G08G 1/017; G06V 10/74; G06T 7/70; G06V 40/19; G06V 20/52; G06V 20/59; G06V 40/20; H04N 7/18; G06V 10/10; H04N 5/232; G08G 1/01; G01S 17/86

(52) U.S. Cl. CPC G08G 1/0175; G06V 10/74; G06T 7/70; G06V 40/19; G06V 20/52; G06V 20/597; G06V 40/20; H04N 7/188; G06V 10/16; H04N 5/23203; G08G 1/0133; G08G 1/0116; G01S 17/86; G06T 2207/30268; G06T 2207/10048; G06T 2207/30201

(57) ABSTRACT

A method for detecting violation of a driving-related law includes producing, by at least one camera, at least one image of a vehicle. The method includes analyzing, by an analysis engine, the at least one image. The analysis engine identifies, based on analyzing the at least one image, a physical position of a driver of the vehicle within the vehicle and identifies a direction of a gaze of the driver. The analysis engine determines that at least one of the physical position of the driver within the vehicle and the direction of the gaze of the driver are associated with a violation of a driving-related law. The method includes transmitting, by a citation mananagement agement component, a notification of the association between the at least one of the physical position of the driver and the direction of the gaze of the driver and the violation, based upon the determination.

### CROSS-REFERENCE TO RELATED APPLICATIONS

This application claims the benefit of U.S. Patent Application Ser. No. 62/900,717, filed on Sep. 16, 2019, entitled “Methods and Systems for Automatically Detecting Violation of a Driving-Related Law,” which is hereby incorporated by reference.

### BACKGROUND

The disclosure relates to enforcement of driving-related laws. More particularly, the methods and systems described herein relate to functionality for automatically detecting violation of a driving-related law.

Many jurisdictions have enacted driving-related laws prohibiting “distracted driving” including visual distractions (in which the driver changes visual focus from driving), manual distractions (in which drivers take their hands off of the steering wheel), cognitive distractions (in which the driver's mind is focused on something other than driving), or combinations of the three. Distractions include, without limitation, eating, grooming, looking at scenery, changing radio stations, focusing on topics of emotional stress or difficulty, interacting with other passengers, and a variety of ways in which driver's may interact with mobile devices (including, for example, programming global positioning systems, calling or texting or emailing or reading text displayed on electronic devices, or reaching for such devices).

Enforcement of these laws or regulations, however, presents a number of challenges. Identifying when a driver is sufficiently distracted to violate a driving-related law or regulation requires reliable imaging of the driver and capturing of data evidencing the distraction. Furthermore, the number of drivers passing a particular point on most major thoroughfares at most rates of speed is such that even if jurisdictions had sufficient human law enforcement officials posted, which many do not, humans are incapable of unassisted identification of violations and simultaneous capture of evidentiary data before the vehicle has passed Although technology exists for determining whether a vehicle has crossed an intersection improperly (e.g., red light cameras) or whether a vehicle passes a particular point at a rate of speed higher than a posted speed limit (e.g., speed guns, speed cameras, and speeding detection tools of varying kinds), such conventional technology typically determines only a position of a vehicle relative to a point (e.g., a point on a road or a speed gun). Such conventional technology does not typically image the interior of the vehicle to determine whether a driver is distracted. Therefore, there is a need for technology that can image the interior of a vehicle and analyze an image of a driver within a time period short enough to capture evidentiary data before the vehicle passes a point of image capture.

### BRIEF SUMMARY

In one aspect, a method for detecting violation of a driving-related law includes producing, by at least one camera, at least one image of a vehicle. The method includes analyzing, by an analysis engine, the at least one image. The method includes identifying, by the analysis engine, based on analyzing the at least one image, a physical position of a driver of the vehicle within the vehicle. The method includes identifying, by the analysis engine, based on analyzing the at least one image, a direction of a gaze of the driver. The method includes determining, by the analysis engine, that at least one of the physical position of the driver within the vehicle and the direction of the gaze of the driver are associated with a violation of a driving-related law. The method includes transmitting, by a citation management component, a notification of the association between the at least one of the physical position of the driver and the direction of the gaze of the driver and the violation, based upon the determination.

In another aspect, a method for method for detecting violation of a driving-related law includes producing, by at least one camera, at least one image of a vehicle. The method includes analyzing, by an analysis engine, the at least one image. The method includes identifying, by the analysis engine, based on analyzing the at least one image, a pose of a driver of the vehicle within the vehicle. The method includes determining, by the analysis engine, that the pose of the driver is associated with a violation of a driving-related law. The method includes transmitting, by a citation management component, a notification of the association between the pose of the driver and the violation, based upon the determination.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a system for automatically detecting violation of a driving-related law;

FIG. 1B is a block diagram depicting an embodiment of a system for automatically detecting violation of a driving-related law;

FIG. 1C is a block diagram depicting an embodiment of a system for automatically detecting violation of a driving-related law;

FIG. 1D is a block diagram depicting an embodiment of a system for automatically detecting violation of a driving-related law;

FIG. 1E is a block diagram depicting an embodiment of a system for automatically detecting violation of a driving-related law;

FIG. 1F is a block diagram depicting an embodiment of a system for automatically detecting violation of a driving-related law;

FIG. 2 is a flow diagram depicting an embodiment of a method for automatically detecting violation of a driving-related law;

FIG. 3 is a flow diagram depicting an embodiment of a method for automatically detecting violation of a driving-related law;

FIG. 4 is a flow diagram depicting an embodiment of a method for automatically detecting violation of a driving-related law; and

FIGS. 5A-5C are block diagrams depicting embodiments of computers useful in connection with the methods and systems described herein.

### DETAILED DESCRIPTION

In some embodiments, the methods and systems described herein provide functionality for automatically detecting violation of a driving-related law. The methods and systems described herein may provide functionality for automatically detecting violations of hands-free driving laws. The methods and systems described herein may provide functionality for automatically detecting violations of seat belt laws.

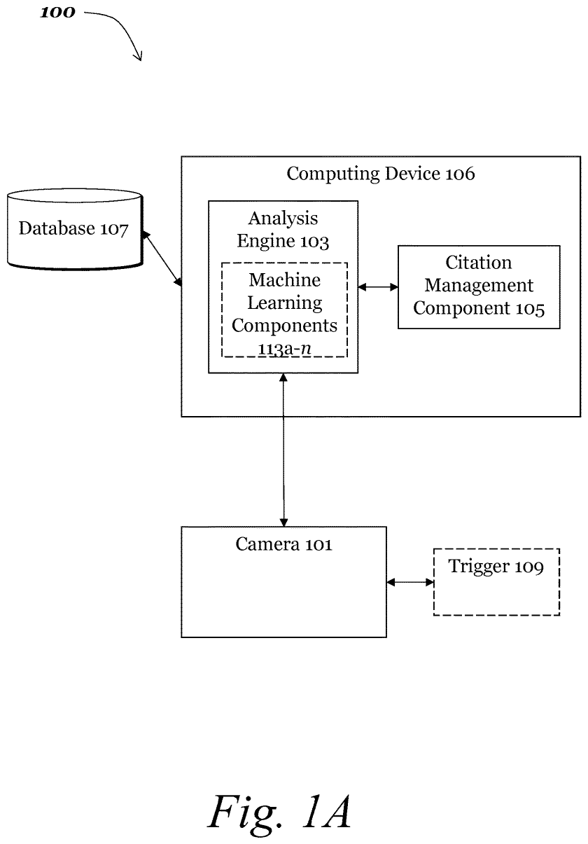

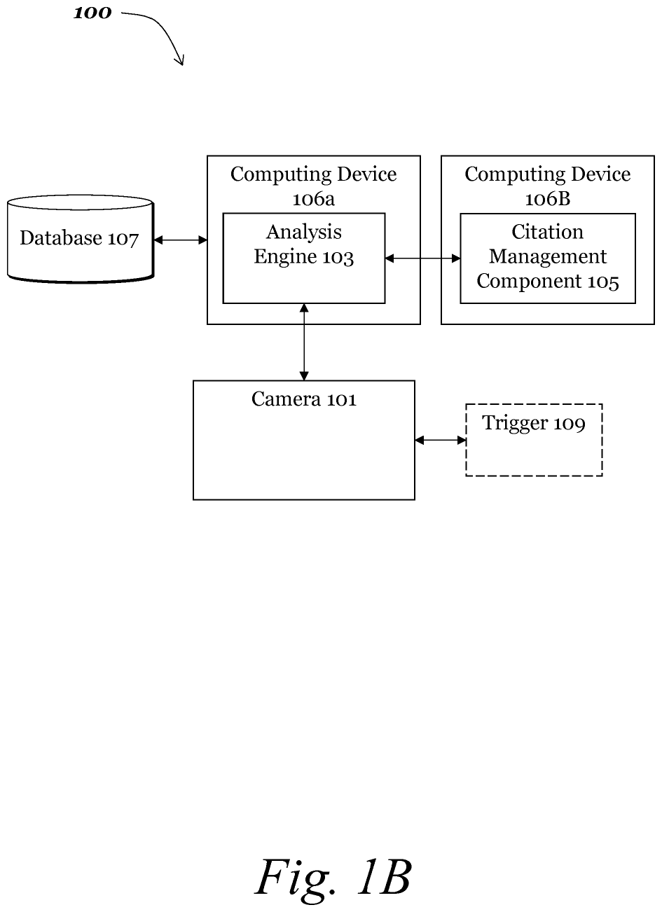

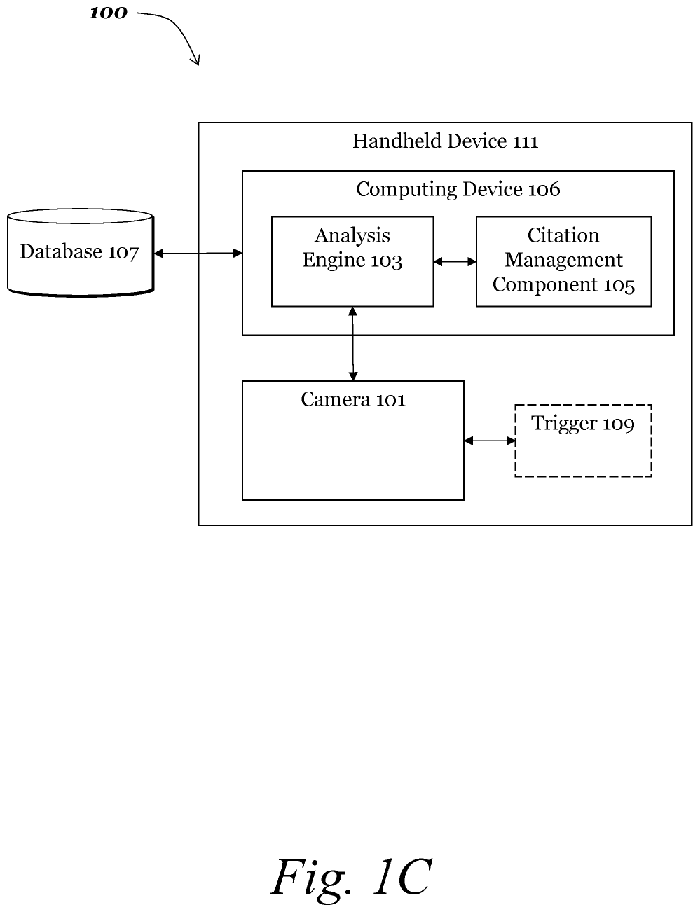

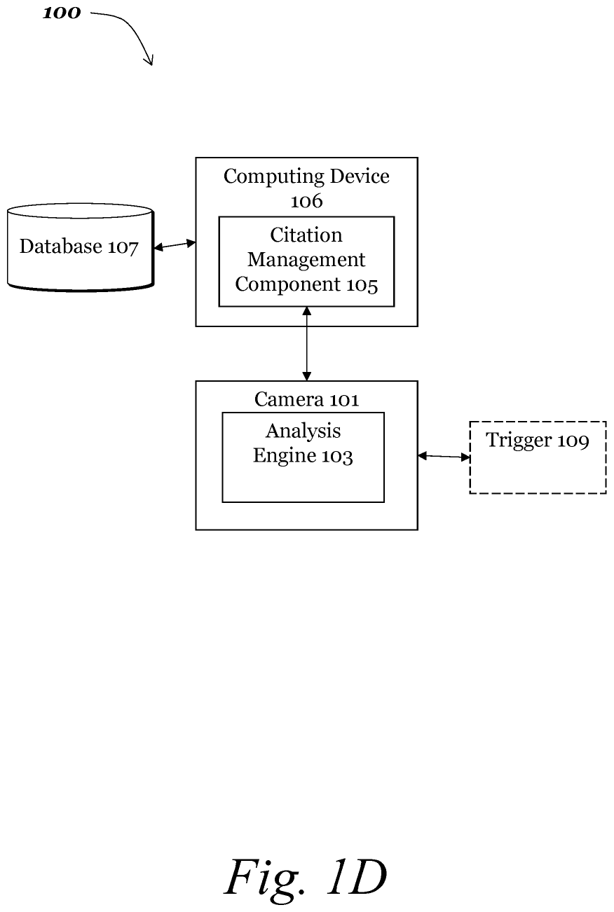

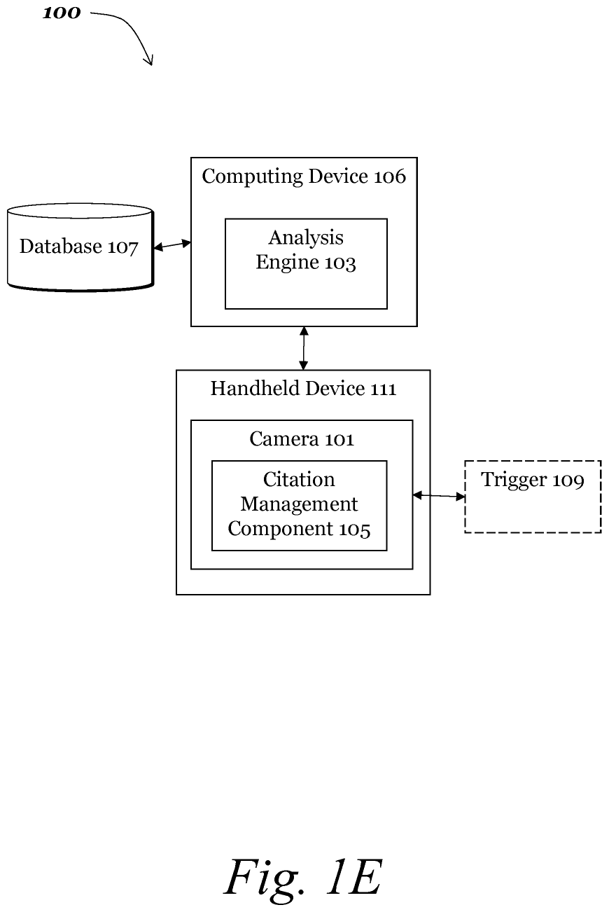

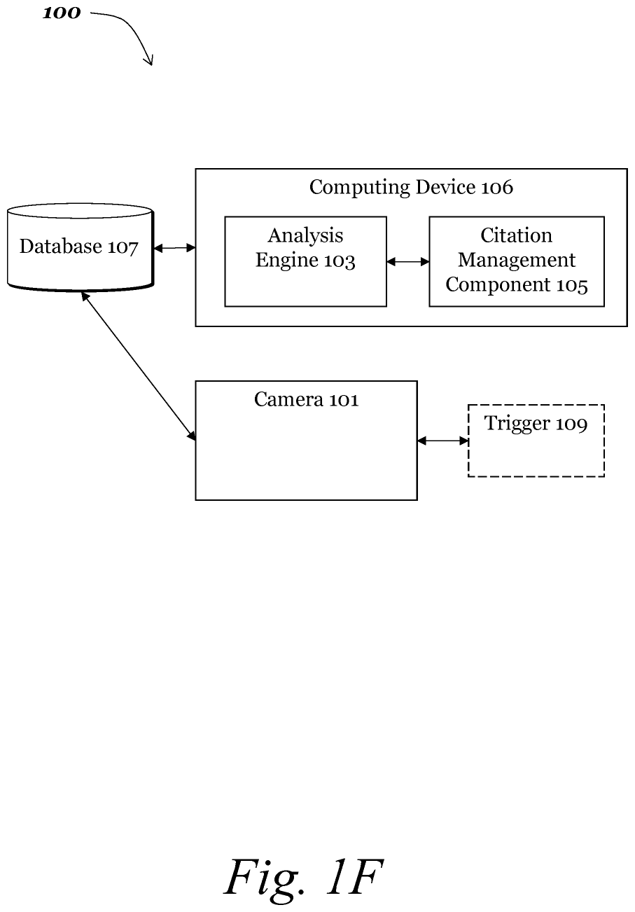

Referring now to FIG. 1A, in brief overview, the system 100 includes a camera 101, an analysis engine 103, a citation management component 105, a computing device 106, and a database 107. The system 100 may optionally include a trigger 109, depicted in shadow in FIG. 1A.

Referring now to FIG. 1A, and in greater detail, the system 100 includes a camera 101. The camera 101 may produce an image. The camera 101 may produce a plurality of images. The camera 101 may product a data set. The camera 101 may be a digital camera. The camera 101 may be an analog camera. The camera 101 may be a still camera. The camera 101 may be a video camera. The camera 101 may be a light detection and ranging (LIDAR) camera. The camera 101 may be an infrared (IR) camera. The camera 101 may be a near infrared (IR) spectrum camera. The camera 101 may be a light-field camera.

The camera 101 may produce an image of a driver's face. The camera 101 may produce an image of a driver's eyes. The camera 101 may produce an image of a driver's glasses.

The camera 101 may include functionality for producing an image that captures a display of a device within the vehicle. As described in further detail below, the system 101 may include functionality for analyzing such an image to determine a type of activity performed by a driver (e.g., watching a video, using a map application, etc.).

The camera 101 may include a flash. The camera 101 may be a floodlight (visual or IR) or illuminator. The camera 101 may include a floodlight (visual or IR) or illuminator. The camera 101 may work in conjunction with a floodlight (visual or IR) or illuminator. In embodiments in which the system 100 includes a floodlight (visual or IR) or illuminator, the methods and systems described herein may avoid or reduce the need for the use of flash photography as continuous lighting may be used instead. In such embodiments, continuous lighting may also facilitate video capture for use in the analyses described below.

The camera 101 may be a structured light and camera. The camera 101 may include a single camera. The camera 101 may include a plurality of stereo vision cameras with at least one structured light (e.g., a flash, floodlight, or other illuminator) with which to take one or more images that allows the analysis engine 103 to make an estimate of a distance between objects (including people) within the vehicle.

The system 100 may include a plurality of cameras 101a-n (not shown). As one example, combining images and/or video produced by multiple camera may improve the ability of the system 100 to determine driver pose, physical position, and gaze, as well as the ability of the system 100 to identify one or more objects in view within the vehicle. As another example, in cases in which a driving-related law prohibits watching videos or looking at images or reading (whether printed or digital material), multiple camera angles or a series of images may be combined to build a more complete image showing a direction of the driver's gaze as well as the driver's physical position and a location of one or more objects proximate to the driver within the vehicle; as an example, and without limitation, an image taken by a front view camera may capture a driver's gaze, while a view from the side of the vehicle or from a camera positioned to capture a view from over the driver's shoulder may show a device proximate to the driver (e.g., on the driver's lap or attached to the dashboard or steering wheel).

The camera 101 may be positioned to produce an over-the-shoulder or side-view image of the driver within the vehicle. The camera 101 may be located, without limitation, anywhere with a view from a side of the driver, including level with or above the driver; a location to the side of the vehicle, including level with or above the vehicle; a location on an adjacent vehicle (e.g., a police car, bus, or other vehicle); a location on an overhead gantry, looking down and in to a vehicle in the next lane (e.g., a camera on gantry above lane to driver's left may look down through driver-side window into driver's lap and at steering wheel); a location from which the camera 101 may produce images of the passenger side of the vehicle; and on a tripod or pole near the road.

The camera 101 may be positioned to produce an image of the inside of the vehicle including the front driver's side of the vehicle.

In some embodiments, the system may integrate a separate speed measuring device (e.g., radar, LIDAR, point-to-point speed sensors) to measure vehicle speed at a time the camera 101 produces the image. Data from such a device or devices may be stored in the database 107. Continuing with this example, if the system later issues, or recommends issuance, of a citation, the citation may include the produced image and the vehicle speed. In other embodiments, the vehicle speed at the time the camera 101 produces the image may be determined by comparing the produced image with a previously produced image (e.g., detecting speed using video or sequential images from the camera 101).

The system 100 may integrate a Global Positioning System (GPS) receiver unit, to give an independent source of current time (or location for a mobile unit). An alternative external system (alternative to GPS) might also provide time data. Data from such a unit may be stored in the database 107.

The system 100 may also interface with municipal database to retrieve data such as registration/license type (commercial, learner); for example, commercial drivers have different and/or stricter laws covering driving and the system 100 may use retrieved data to identify one or more rules to apply in determining whether to issue, or recommend issuance of, a citation. Similarly, individuals driving with a learner's permit may have different and/or stricter hands-free laws. The system 100 may include functionality for extracting a license plate number from an image of a vehicle and using the license plate number to identify a registration type of the vehicle and identify an applicable law or laws based on the registration type.

The camera 101 may be in a fixed position. The camera 101 may be a mobile unit. The camera 101 may be a hand-held device. The camera 101 may be mounted on a vehicle. The camera 101 may be mounted on an aircraft (including, without limitation, unmanned aerial vehicles, helicopters, and other aircraft). The camera 101 may be in motion when the camera 101 produces one or more images. The camera 101 may be stationary when the camera 101 produces one or more images. The camera 101 may be fixed to a traffic signal. The functionality of the camera 101 may be provided by a toll camera. The functionality of the camera 101 may be provided by a traffic stop camera.

The camera 101 may be mounted on, without limitation, a gantry, an overpass, a bridge, a toll plaza, a sign, a light pole, or other overhead structure. The camera 101 may be mounted on a mobile platform. The camera 101 may be mounted on a trailer. The camera 101 may be mounted on or in a vehicle (e.g., a police car). The camera 101 may be mounted on a tripod or pole adjacent to or near the roadway. The camera 101 may be mounted on a fixed installation. The camera 101 may be mounted on a mobile installation. The camera 101 may be mounted on an aircraft. The camera 101 may be mounted on an unmanned aerial vehicle, such as a drone. The camera 101 may be a handheld device. In relation to the vehicle being photographed, the camera 101 may be, without limitation, to the front of the vehicle, to the side of the vehicle, or behind the vehicle. In relation to the vehicle being photographed, the camera 101 may be, without limitation, level with or above the vehicle. In relation to the vehicle being photographed, the camera 101 may be installed within the vehicle (e.g., in rental vehicles or in vehicles in which the driver has agreed to monitoring as a condition of employment).

The camera 101 may be in communication with the analysis engine 103. The camera 101 may be in communication with the database 107.

The system 100 includes an analysis engine 103. In some embodiments, the analysis engine 103 is a software program. In other embodiments, the analysis engine 103 is a hardware module. In further embodiments, the analysis engine 103 is a firmware module. The analysis engine 103 may execute on a computing device 106. The analysis engine 103 may be in communication with the camera 101. The analysis engine 103 may be in communication with the database 107.

The analysis engine 103 may execute one or more machine learning components (depicted in shadow in FIG. 1A as machine learning components 113a-n) for analyzing images produced by the camera 101. The analysis engine 103 may execute neural networks, such as, without limitation, deep convolutional neural networks, residual neural networks, or other artificial neural networks.

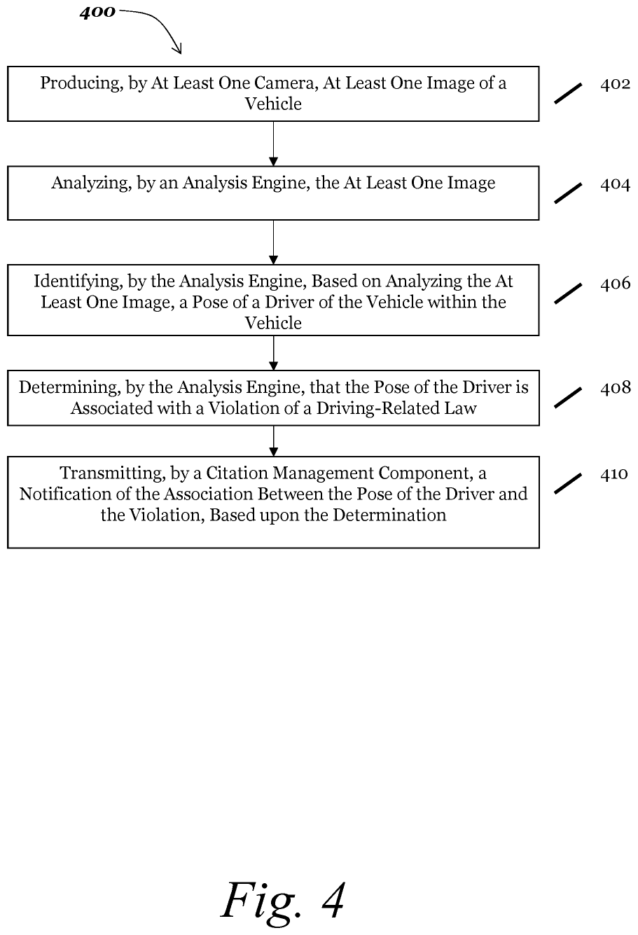

The computing device 106 may be a machine 400 as described below in connection with FIGS. 4A-C and modified by the installation of computer-readable instructions to execute the functionality described herein.

The system 100 includes a citation management component 105. In some embodiments, the citation management component 105 is a software program. In other embodiments, the citation management component is a hardware module. In further embodiments, the citation management component 105 is a firmware module. The citation management component 105 may execute on the computing device 106. The citation management component 105 may be in communication with the analysis engine 103. The analysis engine 103 may provide the functionality of the citation management component 105.

The database 107 may store images. The database 107 may store determinations regarding whether or not a driver of a vehicle was in a position associated with violation of a driving-related law. The database 107 may store indications of whether notifications of the association between physical position of the driver and the violation of the driving-related law were transmitted to any other computing device. The database 107 may store indications of whether notifications of the association between physical position of the driver and the violation of the driving-related law were made available to a user. The database 107 may store an indication of whether a user confirmed the association between the physical position of the driver and the violation of the driving-related law.

In some embodiments, the database 107 is an ODBC-compliant database. For example, the database 107 may be provided as an ORACLE database, manufactured by Oracle Corporation of Redwood Shores, Calif. In other embodiments, the database 107 can be a Microsoft ACCESS database or a Microsoft SQL server database, manufactured by Microsoft Corporation of Redmond, Wash. In other embodiments, the database 107 can be a SQLite database distributed by Hwaci of Charlotte, N.C., or a PostgreSQL database distributed by The PostgreSQL Global Development Group. In still other embodiments, the database 107 may be a custom-designed database based on an open source database, such as the MYSQL family of freely available database products distributed by MySQL AB Corporation of Uppsala, Sweden. In other embodiments, examples of databases include, without limitation, structured storage (e.g., NoSQL-type databases and BigTable databases), HBase databases distributed by The Apache Software Foundation of Forest Hill, Md., MongoDB databases distributed by 10Gen, Inc., of New York, N.Y., an AWS DynamoDB distributed by Amazon Web Services and Cassandra databases distributed by The Apache Software Foundation of Forest Hill, Md. In further embodiments, the database 107 may be any form or type of database.

The system 100 may optionally include a trigger 109. In some embodiments, the trigger 109 is a software program. In other embodiments, the trigger 109 is a hardware module. In further embodiments, the trigger 109 is a firmware module. The trigger 109 may execute on the computing device 106. The trigger 109 may be paired with, or otherwise in communication with, the camera 101. The camera 101 may provide the functionality of the trigger 109; for example, the trigger 109 may be internal to the camera. The trigger 109 may be a radar trigger. The trigger 109 may be a laser trigger. The trigger 109 may be an optical trigger. The trigger 109 may be a magnetic trigger. The trigger 109 may be an induction trigger. The trigger 109 may be a pressure trigger. The trigger 109 may be a motion detection trigger. The camera 101 may include the trigger 109; for example, the camera can continuously take images or include functionality for serving as a motion detector to trigger capturing of an image and subsequent analysis.

The system 100 may integrate with or otherwise be in communication with other third-party cameras or networks. For example, the system 100 may be in communication with (and receiving data from) previously installed cameras monitoring a number of cars at an intersection or cameras monitoring roadway traffic flow.

The system 100 may include functionality for transmitting notice and evidence of violations to nearby law enforcement officers, who may then initiate a traffic stop. For example, a camera 101 on an overpass, vehicle, or aircraft, may transmit information to one or more computing devices operated by police stationed at a roadside or upcoming stoplight; the system may notify the police (via transmission of data to the computing devices operated by the officers), who may then perform regular traffic stop. Those offers may use images received from the system 101 during traffic stop. This may be used, for example, in jurisdictions that do not allow automated ticketing or tickets via mail. The system 101 may include the transmission functionality in the citation management component 105. The system 101 may include the transmission functionality in a separate device/component for sending these notifications.

The system 101 may include separate camera “spotter” and tablet “receiver” components. For example, the system 101 may include functionality (such as an application executing on a second computing device 106b operated by one or more law enforcement officers) to receive information including notice and evidence of violations (e.g. a tablet computer in a police cruiser for receiving violation notifications and images from the remote camera or analysis engine). As another example, one police officer may hold the camera 101 (e.g. at roadside or on an overpass) and another officer may have a receiver in a patrol car for traffic stops; the receiver may include functionality allowing the officer to show photographic evidence of a violation to facilitate traffic stop.

The system 100 may include functionality for indicating to a user that a violation has been detected. For example, a component in the system 101 may have a notification light to signal to nearby police officers that a violation has been detected (e.g., a light on any of the following or on any subset of the following: the analysis engine 103, the citation management component 104, the camera 101, and a computing device 106 executing some or all of the components of the system 100).

Referring now to FIG. 1B, the analysis engine 103 may execute on a first computing device 106a and the citation management component 105 may execute on a second computing device 106b.

Referring now to FIG. 1C, the camera 101, the analysis engine 103, the citation management component 105, the computing device 106, and the optional trigger 109 may all reside on, or be executed by, a handheld device 111.

Referring now to FIG. 1D, the analysis engine 103 may execute on or be provided by the camera 101 and the citation management component 105 may execute on the computing device 106. By way of example, and without limitation, the camera 101 may produce the image and the analysis engine 103 executing on the same device as the camera 101 analyzes the image and determines whether or not to transmit the image and any determinations to the citation management component 105, which may be on a computing device 106 (such as a laptop or server) from which citations may be issued.

Referring now to FIG. 1E, the citation management component 105 may execute on or be provided by the camera 101 and the analysis engine 103 may execute on the computing device 106. By way of example, and without limitation, the camera 101 may produce an image and transmit the image to the analysis engine 103, which performs its analysis and makes a determination regarding whether or not to recommend issuance of a citation and/or whether or not to automatically issue such a citation, and then transmits some or all of the results of its analyses and determinations back to the citation management component 105, which may then provide a notification to a user of some or all of the information received from the analysis engine 103.

Referring now to FIG. 1F, the analysis engine 103 and the citation management component 105 may execute on a computing device 106 and the camera 101 may interact directly with the database 107 but not with the computing device 106.

The system 100 may be integrated with other, pre-existing systems for detecting traffic law violations. As one example, a camera of a third-party system may be modified to transmit images to the database 107 and/or to the analysis engine 103. As another example, the system 100 may be integrated with an existing sensor for detecting when a vehicle exceeds a speed limit. As another example, the system 100 may be integrated with an existing sensor for detecting when a driver of a vehicle has driven through a red light without having right of way. Alternatively, the camera 101 may provide additional functionality for detecting traffic law violations, such as speed limit detection or red light violations.

Although, for ease of discussion, the camera 101, the analysis engine 103, the citation management component 105, the optional trigger 109, and the optional machine learning components 113a-n, are described in FIGS. 1A-F as separate modules, it should be understood that this does not restrict the architecture to a particular implementation. For instance, these components may be encompassed by a single circuit or software function or, alternatively, distributed across a plurality of computing devices.

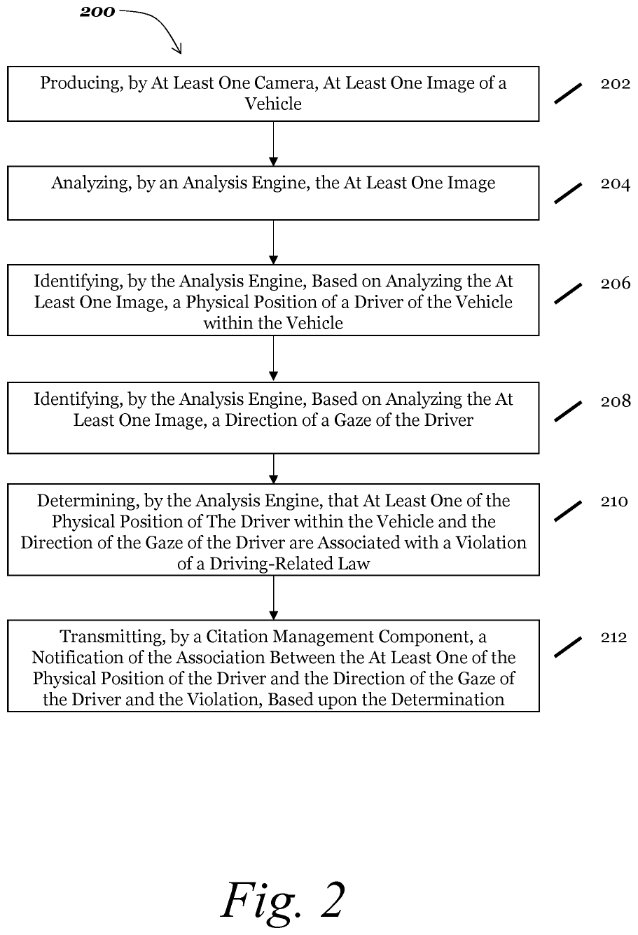

Referring now to FIG. 2, a block diagram depicts one embodiment of a method 200 for automatically detecting violation of a driving-related law. In brief overview, the method 200 includes producing, by at least one camera, at least one image of a vehicle (202). The method 200 analyzing, by an analysis engine, the at least one image (204). The method 200 includes identifying, by the analysis engine, based on analyzing the at least one image, a physical position of a driver of the vehicle within the vehicle (206). The method 200 includes identifying, by the analysis engine, based on analyzing the at least one image, a direction of a gaze of a driver of the vehicle within the vehicle (208). The method 200 includes determining, by the analysis engine, that at least one of the physical position of the driver within the vehicle and the direction of the gaze of the driver are associated with a violation of a driving-related law (210). Although violation of the driving-related law may include use of a mobile phone, the violation may also include, without limitation, use of, personal digital assistants, MP3 or other hand-held music players, electronic reading devices, laptop computers, tablets, computers of any kind, pagers, broadband personal communication devices, GPS or navigation systems, electronic gaming devices, or other portable computing devices. Violations may also include reading text or viewing a video, eating, grooming, holding animals, having an animal located in the front of the vehicle, reading material (whether digital or printed), or gazing for a prolonged period of time at a device that may otherwise appear to satisfy a “hands-free” requirement (such as a device mounted to a vehicle dashboard or windshield). The method 200 includes transmitting, by a citation management component, a notification of the association between the at least one of the physical position of the driver and the direction of the gaze of the driver and the violation, based upon the determination (212).

Referring now to FIG. 2 in greater detail and in connection with FIGS. 1A-F, the method 200 includes producing, by at least one camera, at least one image of a vehicle (202). The camera 101 may produce the at least one image. The camera 101 may produce the at least one image upon receiving a signal from the trigger 109. The camera 101 may produce a plurality of images at periodic intervals (e.g., upon producing a first image at a first time, the camera 101 may produce additional images at subsequent times as specified by a period set by, for example, an administrator). The camera 101 may produce at least one image of the vehicle in motion. The camera 101 may produce at least one image of the vehicle while stopped (e.g., in traffic or at a stop light or other traffic signal). The camera 101 may produce at least one image of the vehicle on a public thoroughfare.

The camera 101 may produce the at least one image using LIDAR. The camera 101 may produce the at least one image using an infrared sensor. The image may be an analog image. The image may be a digital image.

In some embodiments, production of the at least one image may include use of a continuous floodlight or other illuminator, which may facilitate capture of improved images or of video. Use of such an illuminator may leverage use of the camera 101 as a motion detector trigger. In other embodiments, production of the at least one image may include use of a flash.

The camera 101 may produce at least one image including a view of the vehicle looking through a windshield of the vehicle and downwards towards a seat of the vehicle. By way of example, the camera 101 may be located on a highway overpass and produce images from above and ahead of the vehicle. The camera 101 may produce an image from a position to one side of the vehicle. The camera 101 may produce an image from a position ahead of the vehicle. The camera 101 may be a first camera in a plurality of cameras and produce an image that is combined with images produced by other cameras in the plurality of cameras at substantially similar times as the image produced by the first camera 101. In contrast to conventional approaches, therefore, the methods and systems described herein include but are not limited to the use of images that are taken from the front and above a vehicle.

The camera 101 may produce at least one video of the vehicle. The camera 101 may produce at least one still image of the vehicle.

The camera 101 may produce at least one image including an image of the driver's hands. The camera 101 may produce at least one image including an image of the driver's lap.

The camera 101 may store the produced image. In an embodiment in which the camera 101 includes the analysis engine 103, the camera 101 may store and analyze the produced image. In an embodiment in which the analysis engine 103 executes on a device external to (and possibly remote from) the camera 101, the camera 101 may include functionality for transmitting the image directly or indirectly to the analysis engine 103. For example, the camera 101 may transmit the image to a computing device 106 on which the analysis engine 103 executes. As another example, the camera 101 may transmit the image to the database 107 for storage and the analysis engine 103 may retrieve the image from the database 107 for analysis (e.g., upon receiving a notification of a new image available for analysis or upon determining as part of periodic polling of the database 107 that a new image is available for analysis). The method 200 analyzing, by an analysis engine, the at least one image (204).

The analysis engine 103 may perform preprocessing tasks to improve the performance of the machine learning components. The analysis engine 103 may process the at least one image to enhance the at least one image, for example to make one portion of the image larger, enhance a level of contrast in the at least one image, or otherwise enhance the at least one image.

The analysis engine 103 may execute a combination of machine learning components to identify visual glare from a windshield in an image. The analysis engine 103 may execute a combination of machine learning components to remove blur due to motion in the at least one image. The analysis engine 103 may modify at least one image to remove or reduce imperfections or artifacts in an image, such as elements reflecting blur or visual glare.

Before analyzing one or more images, the analysis engine may combine a plurality of images of the vehicle. The analysis engine 103 may combine a plurality of images to remove glare and construct a clearer image. Similarly, analysis engine 103 may combine a plurality of frames in a video to remove glare and construct a clearer image. The analysis 103 may combine a plurality of images (or frames in a video) to adjust for vehicle motion, occlusion, and so on. For example, a single frame may not fully show a driver and a mobile device, but a composite of sequential images may show the driver holding the mobile device with one or both hands.

The analysis engine 103 may analyze the at least one image to identify a position of a driver of the vehicle within the vehicle. The analysis engine 103 may analyze the at least one image to detect and/or identify an object within the vehicle and in proximity to the driver. The analysis engine 103 may execute one or more machine learning components 113a-n to analyze the at least one image. For example, the analysis engine 103 may execute a machine vision component to determine the position of the driver. As another example, the analysis engine 103 may execute a deep learning neural network to determine the position of the driver. As another example, the analysis engine 103 may execute one or more machine learning engines 113a-n to classify an image and perform gaze detection; that is, determine a direction of a gaze of a driver from the image. The analysis engine 103 may execute a plurality of different types of machine learning components 113a-n to analyze the image.

The method 200 includes identifying, by the analysis engine, based on analyzing the at least one image, a physical position of a driver of the vehicle within the vehicle (206). The method 200 includes identifying, by the analysis engine, based on analyzing the at least one image, a direction of a gaze of a driver of the vehicle within the vehicle (208). The combination of identifying the direction of the gaze of the driver and the physical position of the drive may provide improved functionality for determining whether the driver is violating a driving-related law. Other combinations of features of the driver and the vehicle in the at least one image which the analysis engine 103 may identify and analyze instead of or in addition to the combination of physical position of the driver and the direction of the gaze of the driver may include, without limitation, combinations of the physical position of the driver and an identification of one or more objects proximate to the driver's position within the vehicle, combinations of mobile phone display images and the direction of the gaze of the driver, and combinations of the physical position of the driver and a location of one or more objects within the vehicle regardless of direction of gaze of the driver or in conjunction with direction of gaze of the driver (e.g., objects attached to a steering wheel or dashboard, in a cupholder, in a device designed to hold mobile phones, in a location that makes a screen of a mobile phone visible to the driver, and so on).

The analysis engine 103 may execute one or more machine learning components to analyze the at least one image and identify a portion of the at least one image associated with a driver's physical position within the vehicle and to identify the direction of the gaze of the driver.

The analysis engine 103 may execute one or more machine learning components 113a-n to determine a physical position of the driver within the vehicle. The analysis engine 103 may execute a machine learning component 113 to determine the direction of the gaze of the driver of the vehicle. The analysis engine 103 may execute a machine learning component 113 to determine whether both of the driver's hands are on a steering wheel. The analysis engine 103 may execute a machine learning component 113 to determine whether the driver is holding an object in a hand. The analysis engine 103 may execute a machine learning component 113 to determine whether the driver is touching an object.

The analysis engine 103 may execute an object detection component to determine the position of the driver. The analysis engine 103 may execute an object detection component to determine whether the driver is holding an object. Objects may include any of a variety of items that may subsequently be used to determine whether or not there is a violation of a driving-related law. For example, objects may include, without limitation, mobile telephones, personal digital assistant, MP3 or other hand-held music player, electronic reading device, laptop computer, pager, broadband personal communication device, GPS or navigation system, electronic gaming device, or other portable computing device. Objects may also include printed material (e.g., books, magazines, newspapers, and other printed documents).

The analysis engine 103 may compare the identified portion of the at least one image with an image of a driver placing at least one hand on a steering wheel of a second vehicle (e.g., comparing the image produced by the camera 101 with a stock image of another driver of another vehicle with one hand on the steering wheel). The analysis engine 103 may compare the identified portion of the at least one image with an image of a driver placing both hands on a steering wheel of a second vehicle.

As will be understood by those of ordinary skill in the art, one or more machine learning components 113a-n of the analysis engine 103 may access a data set with a number of labeled images, some of which are identified as images showing specific violations and some of which are identified as not showing violations (all of which may be referred to as training data). Images may include images having highlighted areas showing objects suggesting a violation. Images may include associated data, such as indications of a level of probability that an image shows a violation or other data indicating a level of certainty in a label of the image. As will again be understood by those of ordinary skill in the art, configuring the system 100 may include selecting a candidate network architecture (e.g., the layout of nodes, weights, and layers that describes the neural network) and desired output(s) (e.g., “violation=yes/no”, “violation=true/false”, “violation=1/0”); configuring the system 100 may include training the neural network using the training data.

Therefore, as will be understood by those of ordinary skill in the art, one or more machine learning components 113a-n of the analysis engine 103 may detect driver body position, pose, and body parts. Object detection algorithms based on neural networks include, without limitation, R-CNN (Region Convolutional Neural Network), SPP-NET, FAST R-CNN, FASTER R-CNN, YOLO (You Only Look Once), YOLOv2 (You Only Look Once, v2), SSD (Single Shot Detector), and R-FCN (Region-based Fully Convolutional Network). One or more machine learning components 113a-n of the analysis engine 103 may detect objects within the vehicle and the relation of the object location to the location of the driver. One or more machine learning components 113a-n of the analysis engine 103 may detect driver hands and objects located in close proximity to each other. As will be understood by those of ordinary skill in the art, in addition to or instead of neural network based methods of image processing and object detection, the analysis engine 103 may apply techniques for analyzing images including, without limitation, ‘histogram of oriented gradients’ (HOG), Local Binary Pattern (LBP), Scale Invariant Feature Transform (SIFT), Speed Up Robust Features (SURF), and support vector machines.

The analysis engine 103 may also use the geometry of the vehicle to assist with detecting objects within the vehicle. For example, the analysis engine 103 may use known geometries of different models of cars (e.g., retrieved from a database of such geometries) to identify a region of an image depicting a window of a vehicle and crop the image to that portion of the image, reducing the amount of data for analysis in object detection.

In embodiments in which the analysis engine receives one or more images or videos of the mobile device display, the analysis engine 103 may determine a type of data the mobile device is displaying, which in turn may allow the analysis engine 103 to more accurately determine whether the driver is violating a driving-related law, with or without taking into consideration the direction of the gaze of the driver. Types of data may include, without limitation map data, image data, video data, text data, and messaging data. In some embodiments, the analysis engine 103 determines whether or not the type of data is a type of data associated with map applications (e.g., only determining whether the image is or is not of a map). In other embodiments, the analysis engine 103 determines a specific type of data displayed by an application executing or likely to be have been executing at the time the camera 101 produced the image (e.g., specifying whether the data type is video, photo, map, texting, messaging, or other data). Combining one or more images of data displayed by a mobile phone with functionality in the analysis engine 103 for identifying a type of data the mobile phone displays may provide improved functionality for determining whether interaction with the mobile phone data constitutes a violation of a driving-related law. For example, some driving-related laws prohibit typing into a device, including programming a map application, while others allow programming a map application but not creating, sending, or reading text-based communications (such as email or text messages sent by, for example, Short Message Service); other driving-related laws indicate that if a display of a device shows one or more text-based messages, there is a presumption that the driver has been texting; as another example, a driving-related law may indicate that participating in a video call is prohibited. The analysis engine 103 may determine that a driver is in violation of such driving-related laws by analyzing, for example, a direction of gaze of the driver and the type of data displayed by a mobile device in the vehicle with the driver.

The analysis engine 103 may determine a type of data the mobile device (or other computing device within the vehicle) is displaying based on analyzing an image of the mobile device that includes a display area of the mobile device. The analysis engine 103 may execute a machine learning component 113 (e.g., deep learning neural network or other) to classify a type of data displayed by processing the image of what is displayed by the device. This may include having trained the machine learning component 113 on a set of images of data displayed by devices including, without limitation, images of devices displaying maps, images of devices displaying text, images of devices playing videos, and images of devices displaying images; training data may include images from commonly used applications such as maps displayed for a location where the camera 101 operates (e.g., by training the machine learning component 113 on images of what maps look like for the street where the camera 101 is located, the machine learning component 113 will subsequently be able to determine whether a map app in an image of a vehicle passing the camera 101 was displaying a map of the area near the camera 101. After the training process completes, the machine learning component 113 may classify images produced by the camera 101 and provided by the analysis engine 103 to determine a type of data displayed by computing devices in the images. Factors in classification may include image colors, displayed shapes, and typical graphical characteristics of different applications executed by such devices (including trademarks, trade dress, and other characteristic colors, shapes, or icons displayed by applications). Factors may be implicitly learned from data or explicitly incorporated into the machine learning component.

In some embodiments, the analysis engine 103 provides the functionality of determining the type of data of the computing device shown in the image of the interior of the vehicle. The analysis engine 103 may provide the functionality above through a screen display content classification component of the analysis engine 103 (not shown), which may execute a custom machine learning component 113b trained on a different data set than a machine learning component 113a used to determine whether the driver of the vehicle has violated a driving-related law or to perform image analysis; for example, upon determining that an object within the vehicle is a computing device, the analysis engine 103 may then determine a type of data displayed by the object. Alternatively, the analysis engine 103 may be in communication with a screen display content classification component (not shown) that is separate from the analysis engine 103. Therefore, the method may include identifying, by the analysis engine 103, that an image produced by the camera 101 includes a computing device (such as a mobile phone, tablet, or other portable computer); identifying, by the analysis engine 103, a region of the image including the computing device and a display of the computing device (which may further include executing a machine learning component to analyze the image and identify the region); providing, by the analysis engine 103, to a screen display content classification component (executing either internal to the analysis engine 103 or external to the analysis engine 103), the image and the identification of the region; receiving, from the screen display content classification component, a classification of a category or type of displayed data within the identified region of the image (e.g., map, text, non-map, image, chat app, messaging interface, email interface, picture of a face, video, etc.); and using, by the analysis engine 103 the classification of the category of the displayed data in determining whether the image is associated with a violation of a driving-related law. Such steps may be taken substantially simultaneously to other types of analyses executed by the analysis engine 103 (e.g., determining physical position, determining a direction of gaze, or other determinations) or subsequently to those other analyses.

The method 200 includes determining, by the analysis engine, that at least one of the physical position of the driver within the vehicle and the direction of the gaze of the driver is associated with a violation of a driving-related law (210). The analysis engine 103 may identify a portion of an image associated with a driver's seat and identify whether the position of the driver of the vehicle shown in the portion of the image matches positions of drivers shown in other images known to portray drivers seated in a manner that does not violate a driving-related law. The analysis engine 103 may identify a portion of an image associated with a driver's seat and identify whether the direction of the gaze of the driver of the vehicle shown in the portion of the image matches gaze directions of drivers shown in other images known to portray drivers that do not violate a driving-related law. Alternatively, the analysis engine 103 may identify a portion of an image associated with a driver's seat and identify whether the position of the driver of the vehicle shown in the portion of the image matches positions of drivers shown in other images known to portray drivers seated in a manner that does violate a driving-related law. Similarly, the analysis engine 103 may identify a portion of an image associated with a driver's seat and identify whether the direction of the gaze of the driver of the vehicle shown in the portion of the image matches gaze directions of drivers shown in other images known to portray drivers that were found to violate a driving-related law. The analysis engine 103 may determine whether the at least one image of the vehicle has a level of similarity to a second image identified as portraying a violation (or identified as not portraying a violation); the analysis engine 103 may determine whether the level of similarity surpasses a threshold level of similarity sufficient to associate the at least one image with a violation of a driving-related law.

The analysis engine 103 may compare the identified portion of the at least one image produced by the camera 101 with a second image of a second driver, the second image labeled as an image of a driver violating a driving-related law. The analysis engine 103 may compare the identified portion of the at least one image produced by the camera 101 with a second image of a second driver, the second image labeled as an image of a driver not violating a driving-related law. The image comparison may be performed by the analysis engine 103. The image comparison may include performance of a pixel-by-pixel comparison. The image comparison may be performed by one or more machine learning components.

As described above, in connection with the determination at (210), the determination that the physical position of the driver within the vehicle or the direction of the gaze of the driver or both are associated with a violation of a driving-related law may be made by a machine learning component 113 of the analysis engine 103 (such as, without limitation, a deep learning neural network). Therefore, when reference is made herein to a comparison between one or more produced images and one or more other images, this may be an explicit comparison (e.g., pixel-by-pixel) or an implicit comparison (e.g., through the training of a neural network using a training corpus that includes a plurality of labeled images that indicate whether an image includes an object or a driver in a particular physical position or a violation of a law or regulation or other determination as will be understood by those of skill in the art).

The analysis engine 103 may further identify a location of an object other than the driver within the vehicle (e.g., without limitation, the object may be a mobile device, the object may be a firearm, the object may be a food item, the object may be a beverage, the object may be a personal grooming item, the object may be a computer of any kind, the object may a bag, the object may be a container, the object may be any loose object within the vehicle, and the object may be printed materials such as books, magazines, newspapers, and other printed documents). The analysis engine 103 may determine that a combination of the location of the object and the physical position of the driver within the vehicle or the direction of the gaze of the driver (or any combination of the three) is associated with a violation of a driving-related law.

The analysis engine 103 may extract data other than position of the driver and direction of gaze of the driver. The analysis engine 103 may analyze the at least one image to identify a license plate. The analysis engine 103 may analyze the at least one image to identify a face of the driver; facial analysis may include identifying a direction of a gaze of the driver. The analysis engine 103 may analyze the at least one image to identify a make and model of the vehicle. The analysis engine 103 may analyze a plurality of images to identify the speed and direction at which the vehicle is moving. The analysis engine 103 may analyze a plurality of images to identify whether a driver is typing into a device. The analysis engine 103 may analyze a plurality of images to identify whether a driver is scrolling through data displayed on a screen of a device. The analysis engine 103 may use all extracted or analyzed data from the at least one image in determining whether the driver of the vehicle may have violated a driving-related law.

Furthermore, and as will be understood by those of ordinary skill in the art, when the system 100 determines that the at least one image has a characteristic or includes an object (for example, that an image includes a particular object or that a driver in the image is in a particular physical position or that the image is likely to depict a violation of a law or regulation), the system 100 may include functionality for making a determination of a level of certainty associated with the determination (e.g., a percentage or other range or score of likelihood that the system 100 has made a correct determination).

The analysis engine 103 may store data relating to the at least one image in the database 107. The analysis engine 103 may store the at least one image in the database 107. The analysis engine 103 may store a video in the database 107. For example, the analysis engine 103 may store any of the following, a subset of the following, or all of the following: one or more images, one or more video, a time of image production, a date of image production, a location of camera 101, a direction of travel, and other related data. The stored data may be used to generate documents substantiating decisions to issue citations or generate recommendations regarding whether or not citations should be issued. The system 100 may implement encryption or other techniques to validate a chain of custody. In some embodiments, the data is made available to a human user for a human review of the stored data (including any stored images) to determine whether or not to issue a citation.

The analysis engine 103 may include functionality for determining that an image represents an ambiguous case in which it is not clear whether or not to recommend issuance of a citation. The analysis engine 103 may further include functionality for recommending ambiguous cases for human review. The analysis engine 103 may include functionality for executing one or more machine learning engines (or for applying rule sets) to process images (including video) and to manage ambiguity.

The analysis engine 103 may include functionality for recommending any case for human review, whether or not there is a determination of ambiguity. Many jurisdictions require a manual review of images or video before citations are issued. Some review is done by off-duty police officers, some is done by trained civilians. This functionality would allow the system 100 to comply with such requirements. The system 100 may include functionality for capturing and saving video (or still images) of violations and provide either photo evidence or video evidence or both for manual review.

The analysis engine 103 may include functionality for measuring a length of time a driver touches an object (e.g., by using multiple images or video to measure the length of time). Length of time of other distractions may be measured similarly. The analysis engine 103 may include functionality for measuring a number of times a driver touches an object (e.g., by using multiple images or video to measure the number of times). Other factors such as driver position, time of day, weather, traffic, lighting, number of people in the car, and speed may also be used by the analysis engine to apply rules to resolve ambiguity. Some rules might be specified by the police or municipality; these might vary by camera location, road type, time of day. The system 100 may also include functionality for using machine learning engines to automatically apply learned judgement rules, for example by learning from past manual review decisions. to issue citations.

The analysis engine 103 may modify the at least one image. The analysis engine 103 may generate a copy of the at least one image and modify the copy of the at least one image. For example, the analysis engine 103 may add a visual element to the at least one image (or to a copy of the at least one image) identifying an element of the at least one image that contributed to the determination of the association between the position of the driver and the violation of the driving-related law. For instance, the analysis engine 103 may add an arrow, a rectangle, a circle, a geometric shape, a highlighting color, or other visual element to portions of the image that suggest the violation (such as to a hand holding a phone or a chest without a seatbelt). As another example, the analysis engine 103 may distort or blur a portion of an image; for example, the analysis engine 103 may modify the at least one image so that faces of one or more humans inside the vehicle are blurred (e.g., to provide a level of privacy protection for the humans inside the vehicle).

In addition to, or instead of, determining that the physical position of the driver within the vehicle is associated with a violation of a driving-related law by comparing an image of a known violation with the currently produced image (directly as in pixel-by-pixel comparisons or indirectly via execution of one or more neural networks or other machine learning engines trained on corpuses of labeled images, as described above), the analysis engine 103 may identify a characteristic of an image, access a data structure to determine whether that characteristic is mapped to an indication of a likely violation (including, in some embodiments, whether the characteristic support the indication of a violation on its own or in conjunction with other violations). The analysis engine 103 may also, or alternatively, execute deep learning neural network to determine whether that characteristic is mapped to an indication of a likely violation. By way of example, and without limitation, the system 100 may include a data structure indicating that a particular characteristic is associated with a likelihood of violation. By way of example, and without limitation, such a data structure may include a listing of characteristics such as driver pose (e.g., both hands off the steering wheel; driver not facing forward), driver gaze and eye position (e.g., driver not looking forward; driver face and head not looking out of the front of the car for a period of time that exceeds a threshold period of time), driver visibility (e.g., the driver's face is blocked by one or more objects; object location interferes with driver's view; objects are loose upon the dashboard; a map is in front of the driver's face; an object is in front of the driver's face), driver wearing headphones, a hand of the driver is located within a threshold amount of distance from an object (e.g., the driver's hand may be close to or touching an object; the object may be identified using object detection and then a rule may be applied to determine whether there is a violation); an object (e.g., a mobile device) is touching the driver's body; an object (e.g., a mobile device) is in front of the driver's mouth or near the driver's ear; an estimated age of the driver (e.g., based on facial analysis of the driver); an object is located on the driver's lap; a number of people in the vehicle (e.g., in order to enforce a high occupancy vehicle rule); an identification of an unrestrained animal within the vehicle; and combinations of one or more of the above. Characteristics also include whether the driver's gaze or physical position or both is associated with a determination that the driver is viewing a television or video screen; that the driver is composing, sending, reading, accessing, browsing, transmitting, saving, or retrieving electronic data such as e-mail, text messages, or webpages; that a driver is viewing, taking, or transmitting images; and that a driver is playing games. A characteristic may also include driving behavior, alone or in combination with other factors above, such as, without limitation, following another vehicle too closely, driving too slowly, weaving between lanes, failure to signal, speeding, etc. The method may include applying a weight to one or more of these factors when evaluating hands-free violations; for example, speeding and talking on phone may be noted in a citation.

In some embodiments, in addition to the physical position of the driver, the analysis engine 103 may incorporate additional factors determined by image analysis into the determination regarding whether or not there is a violation. For example, the position of the driver may include determining that the direction of the gaze of the driver indicates that the driver is looking down into his or her lap. As another example, the image analysis may include an analysis of a level of light in the vehicle and the analysis engine 103 may determine that an area near the driver's position in the vehicle exhibits a higher level of light than other areas within the vehicle (e.g., due to the light emitted by electronic devices). To the extent that the analysis engine 103 has access to one or more images of the exterior of the vehicle, the analysis engine 103 may determine that the driver is exhibiting one or more characteristics of an individual who is driving while distracted, such as failing to stay within a single lane or leaving a large following gap with other cars; the analysis engine 103 may use these factors in determining whether or not there is a violation.

The method 200 includes transmitting, by a citation management component, a notification of the association between the physical position of the driver and the violation, based upon the determination (212). The citation management component 105 may transmit the notification to a law enforcement official. The citation management component 105 may transmit the notification to an owner of the vehicle. The citation management component 105 may transmit the notification to an insurance company. The citation management component 105 may transmit the notification to another citation management system; for example, the citation management component 105 may transmit the notification to a citation management system maintained by a law enforcement organization and used for determining whether or not to issue citations, and/or issuing citations and/or documenting data related to issued citations.

The citation management component 105 may modify a display of a user interface on a device to transmit the notification (e.g., a device accessed by a law enforcement officer). As indicated above, the citation management component 105 may be in one device (which may be a handheld computing device) while the analysis engine 103 is in another device (such as a remotely located server); the citation management component 105 may receive an indication from the analysis engine 103 regarding whether or not to recommend issuance of a citation or whether or not to automatically issue a citation. The citation management component 105 may modify a display (e.g., of a handheld device 111) to provide an indication to a user of the citation management component 105.

The citation management component 105 may automatically generate and issue a citation in addition to transmitting the notification. The method may, therefore, include automatically producing and processing images and issuing citations for violations.

The citation management component 105 may recommend issuance of a citation. The citation management component 105 may generate and transmit, to a law enforcement official, a recommendation regarding whether or not to issue a citation. The citation management component 105 may determine a level of certainty in the recommendation whether or not to issue a citation; for example, the citation management component 105 may determine that there is a percentage of likelihood that a law enforcement official will issue a citation based upon the recommendation and the citation management component 105 may include that percentage of likelihood with the recommendation. For example, a law enforcement system or official may receive an indication that the system recommends issuing a citation and has associated the recommendation with a level of likelihood of issuance of the citation that exceeds a threshold of likelihood of issuance of the citation (e.g., as pre-defined in the citation management component 105 or as specified by a user of the system 100).

The system 100 may include a user interface for receiving input identifying whether a citation issued by the system was objected to and/or overruled (e.g., whether the driver objected to the citation and a court hearing was held and the system 100 was overruled or upheld). The system 100 may include a user interface for receiving input identifying whether a recommendation to issue a citation was accepted by a law enforcement official. The method 200 may, therefore, include providing user input regarding an issued citation or recommendation regarding whether to issue a citation to the analysis engine 103 for use in modifying one or more components (e.g., machine learning components) to increase a level of accuracy in subsequent analyses.

The method 200 may include providing the at least one image to a reviewer for receiving input regarding at least a portion of the image (e.g., whether an image includes an object or a driver in a particular physical position or a violation of a law or regulation); the method 200 may include providing the at least one image and the input regarding the at least the portion of the image to the analysis engine 103 for use in training the analysis engine 103 (e.g., as additional training data for a machine learning component of the analysis engine 103), resulting in an improved analysis engine 103.

The method 200 may include accessing a municipal database to retrieve information for use in identifying whether a citation was issued by the system and/or whether an issued citation was objected to and/or overruled. For example, the method 200 may include accessing a citation database to determine whether a citation was issued. As another example, the method 200 may include accessing a traffic court database to identify whether an issued citation was objected to and/or overruled. The method 200 may include providing the results of accessing such databases to the analysis engine 103 for further training or refinement of the analysis engine 103.

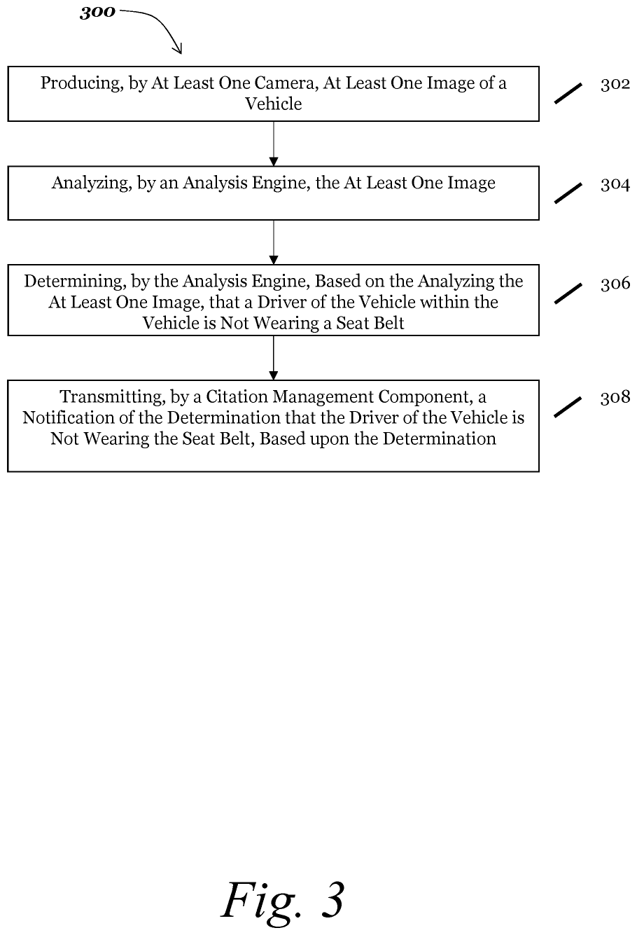

Referring now to FIG. 3, in brief overview, a method 300 for automatically detecting violation of a driving-related law includes producing, by a camera, at least one image of a vehicle (302). The method 300 includes analyzing, by an analysis engine, the at least one image (304). The method 300 includes determining, by the analysis engine, based on the analyzing the at least one image, that a driver of the vehicle within the vehicle is not wearing a seat belt (306). The method 300 includes transmitting, by a citation management component, a notification of the determination that the driver of the vehicle is not wearing the seat belt, based upon the determination (308).

Referring now to FIG. 3, in connection with FIGS. 1A-1F and 2, and in greater detail, the method 300 for automatically detecting violation of a driving-related law includes producing, by a camera, at least one image of a vehicle (302). In some embodiments, (302) is performed as described above in connection with FIG. 2 at (202).

The method 300 includes analyzing, by an analysis engine, the at least one image (304). In some embodiments, analyzing includes identifying a portion of the at least one image associated with a front driver's side seat within the vehicle. In such embodiments, analyzing may further include comparing the identified portion of the at least one image with an image of a driver wearing a seat belt. Comparing the identified portion of the at least one image with the image of the driver wearing the seat belt may include performing a pixel-by-pixel comparison of the images. The analysis engine 103 may execute one or more machine learning components 113a-n to compare the images.

The method 300 includes determining, by the analysis engine, based on the analyzing the at least one image, that a driver of the vehicle within the vehicle is not wearing a seat belt (306). The determination may be made as described above in connection with FIG. 2 (210).

The method 300 includes transmitting, by a citation management component, a notification of the determination that the driver of the vehicle is not wearing the seat belt, based upon the determination (308). The citation management component 105 may operate as described above in connection with FIG. 2, (212).

Referring now to FIG. 4, a block diagram depicts one embodiment of a method 400 for automatically detecting violation of a driving-related law. In brief overview, the method 400 includes producing, by at least one camera, at least one image of a vehicle (402). The method 400 analyzing, by an analysis engine, the at least one image (404). The method 400 includes identifying, by the analysis engine, based on analyzing the at least one image, a pose of a driver of the vehicle within the vehicle (406). The method 400 includes determining, by the analysis engine, that the pose of the driver is associated with a violation of a driving-related law (408). The method 400 includes transmitting, by a citation management component, a notification of the association between the pose of the driver and the violation, based upon the determination (410).

Referring now to FIG. 4, in greater detail, the method 400 includes producing, by at least one camera, at least one image of a vehicle (402). The at least one camera may produce the at least one image of the vehicle as described above in connection with FIG. 2, (202).

The method 400 analyzing, by an analysis engine, the at least one image (404). The analysis engine may analyze the at least one image as described above in connection with FIG. 2, (204).

The method 400 includes identifying, by the analysis engine, based on analyzing the at least one image, a pose of a driver of the vehicle within the vehicle (406). The analysis engine may identify the physical position of the driver as described above in connection with FIG. 2, (206).

The method 400 includes determining, by the analysis engine, that the pose of the driver is associated with a violation of a driving-related law (408). The analysis engine may make the determination as described above in connection with FIG. 2, (210). As indicated above, a pose of the driver may be used to determine that the driver has a pose similar to a pose of a driver previously held to be in violation of a driving-related law or, conversely, that the driver is in a pose that differs from a pose of a driver previously held not to be in violation of a driving-related law. As indicated above, the analysis engine 103 may execute one or more machine learning engines to make the determination. Pose-related violations may include, without limitation, reaching for an object (e.g., reaching for a phone, whether or not the driver touches the phone), smoking or vaping, not maintaining a seated driving position, not maintaining a position in which a seat belt may restrain the driver, holding a pose that blocks the driver's view of the road, holding a phone or other object, eating, grooming, and typing into a device.

The method 400 includes transmitting, by a citation management component, a notification of the association between the pose of the driver and the violation, based upon the determination (410). The citation management component may transmit the notification as described above in connection with FIG. 2, (212).

Although described in certain examples above as relating to automatically identifying drivers who violate seat belt laws or hands-free driving laws, the methods and systems described herein may also be used to automatically identify drivers who violate a variety of laws against distracted driving. For example, the analysis engine 103 may identify whether there is an object of any kind in the driver's hand—cell phones are one example but other objects (food and beverage items, grooming items, and so on) may also violate driving-related laws.

Additionally, although certain examples above describe identifying a position of the driver of the vehicle, the analysis engine 103 may also identify a position of a passenger in a vehicle—for example, determining whether a small child has been seated in the front passenger seat of a vehicle, which may also violate driving-related laws. Such a method may include producing, by at least one camera, at least one image of a vehicle; analyzing, by an analysis engine, the at least one image; identifying, by the analysis engine, based on analyzing the at least one image, a physical position of a passenger of the vehicle within the vehicle; determining, by the analysis engine, that the physical position of the passenger within the vehicle is associated with a violation of a driving-related law; and transmitting, by a citation management component, a notification of the association between the physical position of the driver and the violation, based upon the determination.

Additionally, the analysis engine 103 may identify a number of passengers in the vehicle—for example, determining whether a number of passengers is insufficient to meet a requirement for a high occupancy vehicle (HOV) lane. Such a method may include producing, by at least one camera, at least one image of a vehicle; analyzing, by an analysis engine, the at least one image; identifying, by the analysis engine, based on analyzing the at least one image, a number of passengers within the vehicle; determining, by the analysis engine, that the number of passengers within the vehicle is associated with a violation of a driving-related law; and transmitting, by a citation management component, a notification of the association between the number of passengers and the violation, based upon the determination.

Therefore, in contrast to conventional approaches to identifying violations, the methods and systems described herein provide functionality for identifying a variety of different types of violations, including detection of a driver who is reading or viewing a video, eating, grooming, holding animals, having an animal located in the front of the vehicle, reading material (whether digital or printed), or gazing for a prolonged period of time at a device that may otherwise appear to satisfy a “hands-free” requirement (such as a device mounted to a vehicle dashboard or windshield). Conventional approaches may include discarding or excluding images where the phone is in a holder and not grasped by the driver, although the driver of the vehicle may still be in violation of a driving-related law.

In contrast with conventional methods for identifying violations of driving-related laws, the methods and systems described herein may provide one or more technological improvements. As an example, conventional methods may rely upon detecting radio transmissions from mobile devices as a trigger for detecting violations, which the methods and systems described herein do not require.

In some embodiments, the components described herein may execute one or more functions automatically, that is, without human intervention. For example, the method 200 may include automated production of the at least one image, automated analysis of the produced image, automated identification of the physical position of the driver within the vehicle, automated determining of the association between the image and the possible violation of the driving-related law, and automated transmission of the notification of the association.

It is typically difficult or impossible to enforce hands-free driving laws without the assistance of technology. For example, moving traffic passes through a field of view too fast for a human to see into a car and determine whether there is or is not a violation (much less to capture evidence of the violation); given the limited resolution of the human eye operating at a distance from a moving object and the further restrictions of the human eye during low-visibility or high-glare conditions, a human enforcement officer does not have the ability to make these determinations and capture evidence. The limitations of human attention on a difficult task over time further hampers human abilities to attempt to enforce hands-free driving laws over a large population of drivers at scale. Thus, currently, law enforcement officials are typically limited to enforcing laws only when cars are stopped (e.g., at a traffic light) and, even then, are limited to only enforcing laws on a number of individual drivers that an individual enforcement officer is capable of processing before the light changes (meanwhile, many highways have no lights and have more than 40,000 vehicles pass a given location per day). The system 100, in contrast, is not limited to the constraints of human vision and can inspect multiple lines of moving traffic without being impacted by traffic speed or volume; furthermore, the system 100 can capture evidence and make a determination regarding whether or not the evidence supports a finding of a violation.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment.

The terms “A or B”, “at least one of A or/and B”, “at least one of A and B”, “at least one of A or B”, or “one or more of A or/and B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PYTHON, PROLOG, PERL, C, C++, C#, JAVA, PHP, JavaScript, Node, js or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

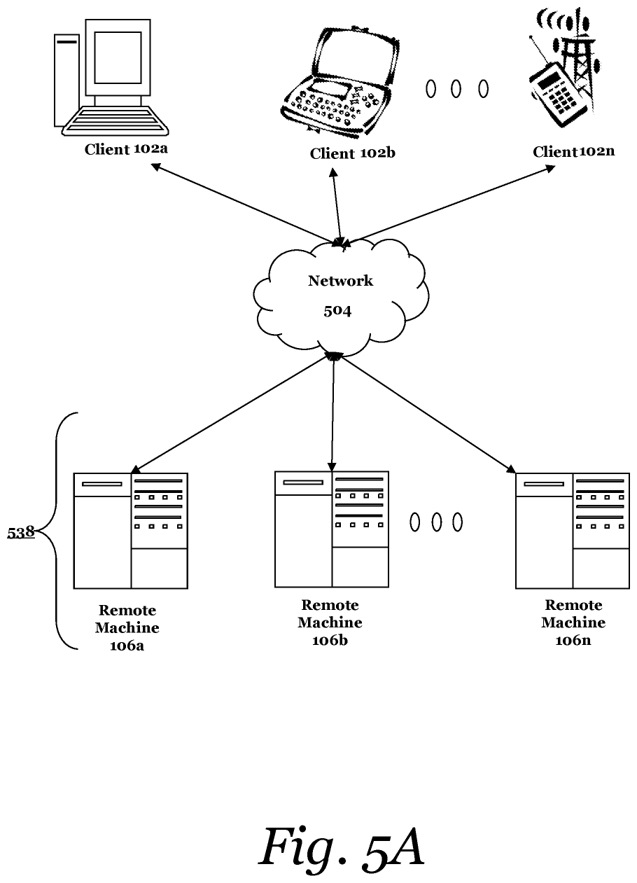

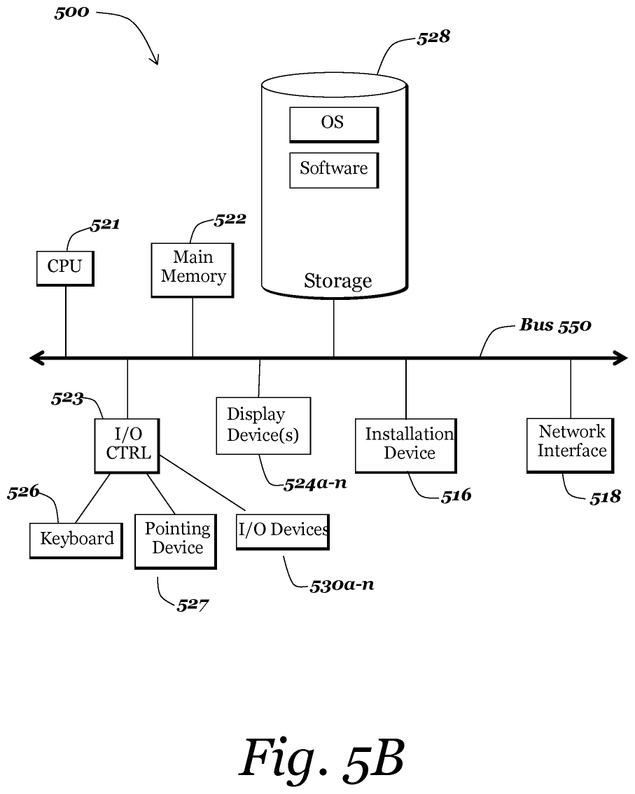

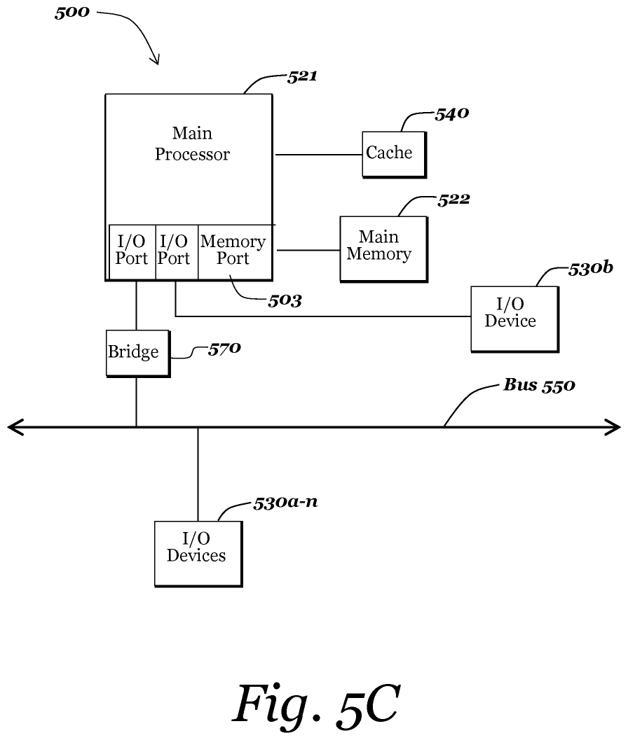

Referring now to FIGS. 5A, 5B, and 5C, block diagrams depict additional detail regarding computing devices that may be modified to execution functionality for implementing the methods and systems described above.

Referring now to FIG. 5A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 504.

Although FIG. 5A shows a network 504 between the client(s) 102 and the remote machines 106, the client(s) 102 and the remote machines 106 may be on the same network 504. The network 504 can be a local area network (LAN), such as a company Intranet, a metropolitan area network (MAN), or a wide area network (WAN), such as the Internet or the World Wide Web. In some embodiments, there are multiple networks 504 between the client(s) and the remote machines 106. In one of these embodiments, a network 504′ (not shown) may be a private network and a network 504 may be a public network. In another of these embodiments, a network 504 may be a private network and a network 504′ a public network. In still another embodiment, networks 504 and 504′ may both be private networks. In yet another embodiment, networks 504 and 504′ may both be public networks.

The network 504 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 504 may comprise a wireless link, such as an infrared channel or satellite band. The topology of the network 404 may be a bus, star, or ring network topology. The network 504 may be of any such network topology as known to those ordinarily skilled in the art capable of supporting the operations described herein. The network 504 may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols. A client(s) 102 and a remote machine 106 (referred to generally as computing devices 100) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client(s) 102 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client(s) 102.

In one embodiment, a computing device 106 provides functionality of a web server. In some embodiments, a web server 106 comprises an open-source web server, such as the NGINX web servers provided by NGINX, Inc., of San Francisco, Calif., or the APACHE servers maintained by the Apache Software Foundation of Delaware. In other embodiments, the web server executes proprietary software, such as the INTERNET INFORMATION SERVICES products provided by Microsoft Corporation of Redmond, Wash., the ORACLE IPLANET web server products provided by Oracle Corporation of Redwood Shores, Calif., or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 538. In another of these embodiments, the server farm 538 may be administered as a single entity.

FIGS. 5B and 5C depict block diagrams of a computing device 500 useful for practicing an embodiment of the client(s) 102 or a remote machine 106. As shown in FIGS. 5B and 5C, each computing device 500 includes a central processing unit 521, and a main memory unit 522. As shown in FIG. 5B, a computing device 500 may include a storage device 528, an installation device 516, a network interface 518, an I/O controller 523, display devices 524a-n, a keyboard 526, a pointing device 527, such as a mouse, and one or more other I/O devices 530a-n. The storage device 528 may include, without limitation, an operating system and software. As shown in FIG. 5C, each computing device 500 may also include additional optional elements, such as a memory port 503, a bridge 570, one or more input/output devices 530a-n (generally referred to using reference numeral 530), and a cache memory 540 in communication with the central processing unit 521.

The central processing unit 521 is any logic circuitry that responds to and processes instructions fetched from the main memory unit 522. In many embodiments, the central processing unit 521 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX “white” boxes, and processors for mobile devices. The computing device 500 may be based on any of these processors, or any other processor capable of operating as described herein.

Main memory unit 522 may be one or more memory chips capable of storing data and allowing any storage location to be directly accessed by the microprocessor 521. The main memory 522 may be based on any available memory chips capable of operating as described herein. In the embodiment shown in FIG. 5B, the processor 521 communicates with main memory 522 via a system bus 550. FIG. 5C depicts an embodiment of a computing device 500 in which the processor communicates directly with main memory 522 via a memory port 503. FIG. 5C also depicts an embodiment in which the main processor 521 communicates directly with cache memory 540 via a secondary bus, sometimes referred to as a backside bus. In other embodiments, the main processor 521 communicates with cache memory 540 using the system bus 550.

In the embodiment shown in FIG. 5B, the processor 521 communicates with various I/O devices 530 via a local system bus 550. Various buses may be used to connect the central processing unit 521 to any of the I/O devices 530, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 524, the processor 521 may use an Advanced Graphics Port (AGP) to communicate with the display 524. FIG. 5C depicts an embodiment of a computing device 500 in which the main processor 521 also communicates directly with an I/O device 530b via, for example, HYPERTRANSPORT, RAPIDIO, or INFINIBAND communications technology.

One or more of a wide variety of I/O devices 530a-n may be present in or connected to the computing device 500, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 523 as shown in FIG. 5B. Furthermore, an I/O device may also provide storage and/or an installation medium 516 for the computing device 500. In some embodiments, the computing device 500 may provide USB connections (not shown) to receive handheld USB storage devices such as the USB Flash Drive line of devices manufactured by Twintech Industry, Inc. of Los Alamitos, Calif.

Referring still to FIG. 5B, the computing device 500 may support any suitable installation device 516, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 500 may provide functionality for installing software over a network 504. The computing device 500 may further comprise a storage device, such as one or more hard disk drives or redundant arrays of independent disks, for storing an operating system and other software. Alternatively, the computing device 500 may rely on memory chips for storage instead of hard disks.

Furthermore, the computing device 500 may include a network interface 518 to interface to the network 504 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 500 communicates with other computing devices 500′ via any type and/or form of gateway or tunneling protocol such as Secure Socket Layer (SSL) or Transport Layer Security (TLS). The network interface 518 may comprise a built-in network adapter, network interface card, PCMCIA network card, card bus network adapter, wireless network adapter, USB network adapter, modem, or any other device suitable for interfacing the computing device 500 to any type of network capable of communication and performing the operations described herein.

In further embodiments, an I/O device 530 may be a bridge between the system bus 550 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 500 of the sort depicted in FIGS. 5B and 5C typically operates under the control of operating systems, which control scheduling of tasks and access to system resources. The computing device 500 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.1-4.0, WINDOWS CE, WINDOWS XP, WINDOWS 7, WINDOWS 8, WINDOWS VISTA, and WINDOWS 10, all of which are manufactured by Microsoft Corporation of Redmond, Wash,; any version of MAC OS manufactured by Apple Inc. of Cupertino, Calif.; OS/2 manufactured by International Business Machines of Armonk, N.Y.; Red Hat Enterprise Linux, a Linus-variant operating system distributed by Red Hat, Inc., of Raleigh, N.C.; Ubuntu, a freely-available operating system distributed by Canonical Ltd. of London, England; or any type and/or form of a Unix operating system, among others.

The computing device 500 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 500 may have different processors, operating systems, and input devices consistent with the device. In other embodiments, the computing device 500 is a mobile device, such as a JAVA-enabled cellular telephone/smartphone or personal digital assistant (PDA). The computing device 500 may be a mobile device such as those manufactured, by way of example and without limitation, by Apple Inc. of Cupertino, Calif.; Google/Motorola Div. of Ft. Worth, Tex.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif.; Sony Ericsson Mobile Communications AB of Lund, Sweden; or Research In Motion Limited of Waterloo, Ontario, Canada. In yet other embodiments, the computing device 500 is a smartphone, POCKET PC, POCKET PC PHONE, or other portable mobile device supporting Microsoft Windows Mobile Software.

In some embodiments, the computing device 500 is a digital audio player. In one of these embodiments, the computing device 500 is a digital audio player such as the Apple IPOD, IPOD TOUCH, IPOD NANO, and IPOD SHUFFLE lines of devices manufactured by Apple Inc. In another of these embodiments, the digital audio player may function as both a portable media player and as a mass storage device. In other embodiments, the computing device 500 is a digital audio player such as those manufactured by, for example, and without limitation, Samsung Electronics America of Ridgefield Park, N.J., or Creative Technologies Ltd. of Singapore. In yet other embodiments, the computing device 500 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 500 comprises a combination of devices, such as a mobile phone combined with a digital audio player or portable media player. In one of these embodiments, the computing device 500 is a device in the Google/Motorola line of combination digital audio players and mobile phones. In another of these embodiments, the computing device 500 is a device in the IPHONE smartphone line of devices manufactured by Apple Inc. In still another of these embodiments, the computing device 500 is a device executing the ANDROID open source mobile phone platform distributed by the Open Handset Alliance; for example, the device 500 may be a device such as those provided by Samsung Electronics of Seoul, Korea, or HTC Headquarters of Taiwan, R.O.C. In other embodiments, the computing device 500 is a tablet device such as, for example and without limitation, the IPAD line of devices manufactured by Apple Inc.; the PLAYBOOK manufactured by Research In Motion; the CRUZ line of devices manufactured by Velocity Micro, Inc. of Richmond, Va.; the FOLIO and THRIVE line of devices manufactured by Toshiba America Information Systems, Inc. of Irvine, Calif.; the GALAXY line of devices manufactured by Samsung; the HP SLATE line of devices manufactured by Hewlett-Packard; and the STREAK line of devices manufactured by Dell, Inc. of Round Rock, Tex.

Having described certain embodiments of methods and systems for automatically detecting violation of a driving-related law, it will now become apparent to one of skill in the art that other embodiments incorporating the concepts of the disclosure may be used. Therefore, the disclosure should not be limited to certain embodiments, but rather should be limited only by the spirit and scope of the following claims.

1. A method for detecting violation of a driving-related law, the method comprising:
producing, by at least one camera, at least one image of a vehicle;
analyzing, by an analysis engine, the at least one image;
identifying, by the analysis engine, based on analyzing the at least one image, a physical position of a driver of the vehicle within the vehicle;
identifying, by the analysis engine, based on analyzing the at least one image, a direction of a gaze of the driver;
determining, by the analysis engine, that at least one of the physical position of the driver within the vehicle and the direction of the gaze of the driver are associated with a violation of a driving-related law; and
transmitting, by a citation management component, a notification of the association between the at least one of the physical position of the driver and the direction of the gaze of the driver and the violation, based upon the determination.

2. The method of claim 1, wherein producing further comprises producing at least one video of the vehicle.

3. The method of claim 1, wherein producing further comprises producing at least one still image of the vehicle.

4. The method of claim 1, wherein producing further comprises producing, by a light detection and ranging (LIDAR) camera, the at least one image of the vehicle.

5. The method of claim 1, wherein producing further comprises producing, by an infrared (IR) camera, the at least one image of the vehicle.

6. The method of claim 1, wherein producing further comprises producing, by the at least one camera, the at least one image of the vehicle upon receiving a signal from a triggering device.

7. The method of claim 1, wherein producing further comprises producing, by the at least one camera, the at least one image of the vehicle, the at least one image including a view of the vehicle looking through a windshield of the vehicle and downwards towards a seat of the vehicle.

8. The method of claim 1 further comprising, before analyzing, by the analysis engine, the at least one image, combining, by the analysis engine, a plurality of images of the vehicle.

9. The method of claim 1, wherein analyzing further comprises analyzing, by a machine learning component of the analysis engine, the at least one image.

10. The method of claim 1, wherein analyzing the at least one image further comprises identifying a portion of the at least one image associated with a driver's position within the vehicle.

11. The method of claim 10, wherein analyzing the at least one image further comprises comparing the identified portion of the at least one image with an image of a driver placing at least one hand on a steering wheel of a second vehicle.

12. The method of claim 11, wherein comparing the identified portion of the at least one image with an image of the driver placing at least one hand on the steering wheel of the second vehicle further comprises performing a pixel-by-pixel comparison.

13. The method of claim 1, wherein identifying further comprises identifying a location of an object within the vehicle.

14. The method of claim 13, wherein determining further comprises determining that a combination of the location of the object and the physical position of the driver within the vehicle is associated with a violation of a driving-related law.

15. The method of claim 13, wherein identifying further comprises identifying a location of a mobile device within the vehicle.

16. The method of claim 13, wherein identifying further comprises identifying a location of a firearm within the vehicle.

17. The method of claim 1, wherein transmitting further comprises transmitting, by the citation management component, the notification further comprises transmitting the notification to a law enforcement officer.

18. The method of claim 1, wherein transmitting further comprises transmitting, by the citation management component, the notification further comprises transmitting the notification to an owner of the vehicle.

19. The method of claim 1, wherein transmitting further comprises transmitting the notification further comprises modifying a display on a user interface of a device accessed by a law enforcement officer.

20. A method for detecting violation of a driving-related law, the method comprising:
producing, by at least one camera, at least one image of a vehicle;
analyzing, by an analysis engine, the at least one image;
identifying, by the analysis engine, based on analyzing the at least one image, a pose of the driver of the vehicle within the vehicle;
determining, by the analysis engine, that the pose of the driver is associated with a violation of a driving-related law; and
transmitting, by a citation management component, a notification of the association between the pose of the driver and the violation, based upon the determination.
